(19) United States
(12) Patent Application Publication
(10) Pub. No.: US 2019/0126554 A1
(43) Pub. Date: May 2, 2019

(54) THREE-DIMENSIONAL PRINTING APPARATUS

(71) Applicant: Roland DG Corporation, Hamamatsu-shi (JP)

(72) Inventor: Fumiyoshi IWASE, Hamamatsu-shi (JP)

(21) Appl. No.: 16/145,419

(22) Filed: Sep. 28, 2018

(30) Foreign Application Priority Data
Oct. 27, 2017 (JP) 2017-208143

(51) Int. Cl. B29C 64/35; B33Y 30/00; B33Y 40/00; B29C 64/209; B29C 64/236; B29C 64/393; B33Y 50/02

(52) U.S. Cl. CPC B29C 64/35; B33Y 30/00; B33Y 40/00; B33Y 50/02; B29C 64/236; B29C 64/393; B29C 64/209

(57) ABSTRACT

A three-dimensional printing apparatus includes a holder, a printing tank, a printing table, line heads, a conveyor, a nozzle checker, and a controller. The printing tank stores a powder material to be placed on the printing table in a printing space of the printing tank. The line heads each include nozzles to discharge a curing liquid onto the powder material on the printing table. The conveyor moves the holder relative to the line heads in a scanning direction. The nozzle checker is disposed in the holder and checks the nozzles for discharge failures. The controller controls discharge of the curing liquid from the nozzles and includes a discharge controller to cause the nozzles to discharge the curing liquid onto the nozzle checker.

### CROSS REFERENCE TO RELATED APPLICATIONS

This application claims the benefit of priority to Japanese Patent Application No. 2017-208143 filed on Oct. 27, 2017. The entire contents of this application are hereby incorporated herein by reference.

### BACKGROUND OF THE INVENTION

### 1. Field of the Invention

The present invention relates to three-dimensional printing apparatuses.

### 2. Description of the Related Art

As disclosed in Japanese Patent No. 5400042, a powder lamination manufacturing technique known in the related art involves discharging a binder onto a powder material and curing the powder material so as to print a desired three-dimensional object.

A three-dimensional printing apparatus disclosed in Japanese Patent No. 5400042, for example, includes: a printing unit that holds powder; a powder feeder that stores powder to be fed to the printing unit; and an inkjet line head (hereinafter referred to as a “line head”) disposed above the printing unit. The line head discharges water-based ink onto powder held in the printing unit. Specifically, the line head discharges water-based ink onto a portion of the powder corresponding to a cross-sectional shape of a three-dimensional object to be printed. The portion of the powder onto which the water-based ink is discharged is cured so as to define a cured layer corresponding to the cross-sectional shape. Sequentially stacking such cured layers prints a desired three-dimensional object.

Printing a three-dimensional object by a powder lamination manufacturing technique may cause a powder material to adhere to a nozzle of a line head, resulting in clogging of the nozzle. To solve this problem, a three-dimensional printing apparatus is desirably provided with a maintenance device to perform maintenance, such as cleaning, so as to reduce or eliminate nozzle clogging. Unfortunately, three-dimensional printing apparatuses known in the related art are unable to determine whether nozzle clogging has occurred between the start and end of three-dimensional object printing. This forces users to perform maintenance, for example, before the start of three-dimensional object printing so as to reduce or eliminate nozzle clogging. Occurrence of nozzle clogging in the course of printing may make it impossible to suitably cure a powder material, resulting in insufficient strength of a finished three-dimensional object.

### SUMMARY OF THE INVENTION

Accordingly, preferred embodiments of the present invention provide three-dimensional printing apparatuses that are able to determine whether nozzle clogging has occurred.

A preferred embodiment of the present invention provides a three-dimensional printing apparatus to print a three-dimensional object by sequentially stacking cured layers each defined by a cured powder material. The three-dimensional printing apparatus includes a holder, a printing tank, a printing table, a discharge head, a conveyor, a nozzle checker, and a controller. The holder holds the three-dimensional object being printed. The printing tank is disposed in the holder. The printing tank includes a printing space in which the powder material is to be stored. The powder material is to be placed on the printing table. The printing table is disposed in the printing space of the printing tank. The discharge head includes a plurality of nozzles to discharge a curing liquid onto the powder material placed on the printing table, and a nozzle surface provided with the nozzles. The conveyor moves one of the holder and the discharge head relative to the other one of the holder and the discharge head in a first direction. The nozzle checker is disposed in the holder. The nozzle checker checks at least one of the nozzles for a discharge failure. The controller controls discharge of the curing liquid from the nozzles. The controller includes a discharge controller to cause the nozzles to discharge the curing liquid onto the nozzle checker.

The holder of the three-dimensional printing apparatus according to the present preferred embodiment is provided with the nozzle checker. The discharge controller of the controller causes the nozzles of the discharge head to discharge the curing liquid onto the nozzle checker. The nozzle checker is able to check at least one of the nozzles for a discharge failure. The three-dimensional printing apparatus according to the present preferred embodiment causes the nozzles to discharge the curing liquid onto the nozzle checker before the start of printing of the three-dimensional object and/or in the course of printing of the three-dimensional object so as to detect whether each nozzle is clogged. In the event of a discharge failure in at least one of the nozzles, an operator may stop the printing of the three-dimensional object so as to perform maintenance of the nozzle(s).

Various preferred embodiments of the present invention provide three-dimensional printing apparatuses that are able to determine whether nozzle clogging has occurred.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic cross-sectional view of a three-dimensional printing apparatus according to a first preferred embodiment of the present invention, with a head unit located at a home position.

FIG. 2 is a schematic plan view of the three-dimensional printing apparatus according to the first preferred embodiment of the present invention.

FIG. 3 is a schematic plan view of the head unit and a portion of a holder.

FIG. 4 is a schematic diagram illustrating a nozzle checker according to the first preferred embodiment of the present invention.

FIG. 5 is a block diagram of the three-dimensional printing apparatus according to the first preferred embodiment of the present invention.

FIG. 6 is a flow chart illustrating a procedure for printing a three-dimensional object.

FIG. 7 is a schematic cross-sectional view of the three-dimensional printing apparatus according to the first preferred embodiment of the present invention, with line heads located over a printing tank.

FIG. 8 is a schematic cross-sectional view of the three-dimensional printing apparatus according to the first preferred embodiment of the present invention, with the line heads located over the nozzle checker.

FIG. 9 is a schematic cross-sectional view of the three-dimensional printing apparatus according to the first preferred embodiment of the present invention, with the line heads located over a flushing stage.

FIG. 10 is a schematic diagram illustrating a nozzle checker according to a second preferred embodiment of the present invention.

### DETAILED DESCRIPTION OF THE PREFERRED EMBODIMENTS

### First Preferred Embodiment

Three-dimensional printing apparatuses according to preferred embodiments of the present invention will be described below with reference to the drawings. The preferred embodiments described below are naturally not intended to limit the present invention in any way. Components or elements having the same functions are identified by the same reference signs, and description thereof will be simplified or omitted when deemed redundant.

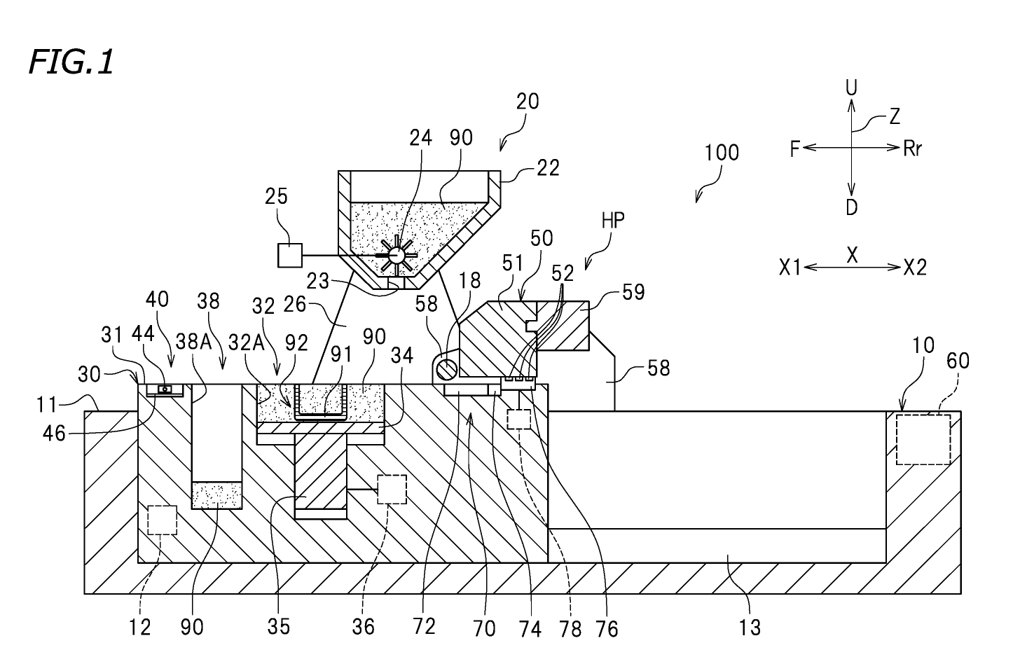

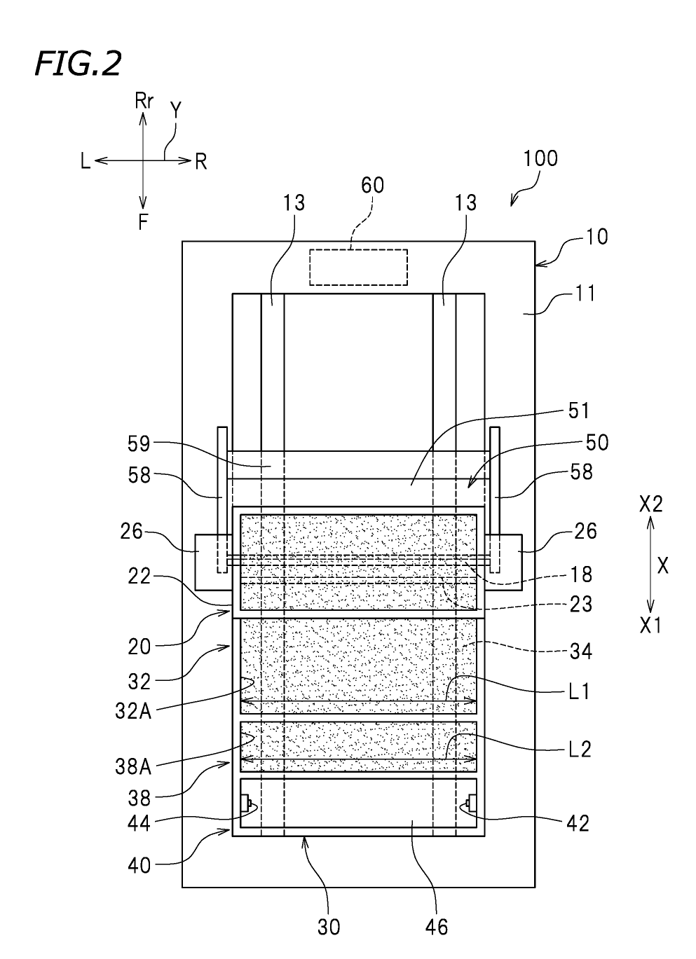

FIG. 1 is a cross-sectional view of a three-dimensional printing apparatus 100 according to a first preferred embodiment of the present invention. FIG. 2 is a plan view of the three-dimensional printing apparatus 100 according to the first preferred embodiment of the present invention. The reference sign F in the drawings represents front. The reference sign Rr in the drawings represents rear. As used herein, the terms “right”, “left”, “up”, and “down” respectively refer to right, left, up, and down with respect to an operator facing the front of the three-dimensional printing apparatus 100. The reference signs R, L, U, and D in the drawings respectively represent right, left, up, and down. The reference signs X, Y, and Z in the drawings respectively represent a front-rear direction, a right-left direction, and an up-down direction. The front-rear direction X may also be referred to as a “scanning direction X”. The front-rear direction X corresponds to a “first direction”. The up-down direction Z corresponds to a direction in which layers of a three-dimensional object are to be stacked. The rear side of the three-dimensional printing apparatus 100 may also be referred to as an “upstream side”. The front side of the three-dimensional printing apparatus 100 may also be referred to as a “downstream side”. As used herein, the term “onward direction X1” refers to a direction from the upstream side to the downstream side, and the term “backward direction X2” refers to a direction from the downstream side to the upstream side. These directions are defined merely for the sake of convenience of description and do not limit in any way how the three-dimensional printing apparatus 100 may be installed.

As illustrated in FIG. 1, the three-dimensional printing apparatus 100 cures a powder material 90 with a curing liquid so as to define cured layers 91. The three-dimensional printing apparatus 100 sequentially stacks the cured layers 91 in the up-down direction Z such that the cured layers 91 are integral with each other. The three-dimensional printing apparatus 100 thus prints a desired three-dimensional object 92. In accordance with a cross-sectional image indicative of a cross-sectional shape of the desired three-dimensional object 92, the three-dimensional printing apparatus 100 according to the present preferred embodiment discharges a curing liquid onto the powder material 90 so as to cure the powder material 90 and define the cured layer corresponding to the cross-sectional image. The three-dimensional printing apparatus 100 sequentially stacks the cured layers 91 so as to print the desired three-dimensional object 92.

As used herein, the term “cross-sectional shape” refers to a cross-sectional shape obtained when a model of the three-dimensional object 92 to be printed is cut into slices in a predetermined direction (e.g., a horizontal direction) such that each of the slices has a predetermined thickness (e.g., a thickness of about 0.1 mm). Each of the slices does not necessarily have to have a constant thickness.

The powder material 90 is not limited to any particular composition or form. The powder material 90 may be powder made of any of various materials, such as a resin material, a metal material, and an inorganic material. Examples of components of the powder material 90 include: ceramic materials, such as alumina, silica, titania, and zirconia; metal materials, such as iron, aluminum, titanium, and an alloy thereof (which is typically stainless steel, a titanium alloy, or an aluminum alloy); and other materials, such as gypsum hemihydrate (e.g., α type calcined gypsum and β type calcined gypsum), apatite, salt, and plastic. The powder material 90 may include any one of these components or may be a combination of two or more of these components.

The curing liquid may be any liquid that causes particles of the powder material 90 to adhere to each other. Examples of the curing liquid to be used include a liquid that binds together particles of the powder material 90. The curing liquid may be viscous. Examples of the curing liquid include a liquid containing water, wax, and/or a binder. When the powder material 90 contains water-soluble resin as a secondary component, a liquid (such as water) that is able to dissolve the water-soluble resin may be used as the curing liquid. The water-soluble resin is not limited to any particular water-soluble resin. Examples of the water-soluble resin include starch, polyvinyl alcohol (PVA), polyvinyl pyrrolidone (PVP), water-soluble acrylic resin, water-soluble urethane resin, and water-soluble polyamide.

As illustrated in FIG. 1, the three-dimensional printing apparatus 100 includes a body 10, a conveyor 12, a spreading roller 18, a powder feeder 20, a holder 30, a head unit 50, and a controller 60.

As illustrated in FIG. 2, the body 10 is an outer body of the three-dimensional printing apparatus 100. The body 10 is elongated in the scanning direction X. The body 10 has a box shape that is open upward. The body 10 holds the conveyor 12 (see FIG. 1), the holder 30, and the controller 60. The body 10 also defines and functions as a support base that supports the spreading roller 18, the powder feeder 20, and the head unit 50. The body 10 is provided with a pair of guide rails 13. The guide rails 13 guide movement of the holder 30 in the scanning direction X. The guide rails 13 extend in the scanning direction X. Alternatively, any number of guide rails 13 may be disposed at any locations.

As illustrated in FIG. 1, the holder 30 is held in the body 10. The holder 30 holds the three-dimensional object 92 being printed. The holder 30 is in slidable engagement with the guide rails 13. The holder 30 includes a printing tank 32, a printing table 34, a raising and lowering device 36, and an excess powder collecting tank 38. The holder 30 includes a flat upper surface 31. The printing tank 32 and the excess powder collecting tank 38 are recessed from the upper surface 31 of the holder 30. The printing tank 32 and the excess powder collecting tank 38 are arranged independently side by side.

As illustrated in FIG. 1, the printing tank 32 is disposed in the holder 30. The printing tank 32 stores the powder material 90. The three-dimensional object 92 is to be printed in the printing tank 32. The printing tank 32 includes a printing space 32A in which the powder material 90 fed from the powder feeder 20 is to be stored. The curing liquid is discharged onto the powder material 90 so as to print the three-dimensional object 92 in the printing space 32A.

As illustrated in FIG. 1, the printing table 34 is disposed in the printing space 32A of the printing tank 32. The powder material 90 is placed on the printing table 34. The three-dimensional object 92 is printed in a portion of the printing space 32A located on the printing table 34. The printing table 34 is movable in the up-down direction Z. In one example, the printing table 34 has a rectangular shape in a plan view. The printing table 34 is provided with a table support 35. The table support 35 extends downward from the bottom surface of the printing table 34. The table support 35 is movable together with the printing table 34 in the up-down direction Z.

The raising and lowering device 36 moves the printing table 34 in the up-down direction Z. In other words, the raising and lowering device 36 raises and lowers the printing table 34. The raising and lowering device 36 is not limited to any particular configuration. In the present preferred embodiment, the raising and lowering device 36 includes a servomotor (not illustrated) and a ball screw (not illustrated). In one example, the servomotor is connected to the table support 35 and is connected to the printing table 34 through the table support 35. Driving the servomotor moves the table support 35 in the up-down direction Z. The movement of the table support 35 in the up-down direction Z moves the printing table 34 in the up-down direction Z. The raising and lowering device 36 is disposed in the holder 30. The raising and lowering device 36 is electrically connected to the controller 60 and is thus controlled by the controller 60.

When the powder material 90 fed into the printing tank 32 is spread through the printing tank 32 by the spreading roller 18, the excess powder collecting tank 38 collects an excess portion of the powder material 90 that is not stored in the printing tank 32. The excess powder collecting tank 38 includes a storing space 38A in which the excess portion of the powder material 90 is to be stored. The excess powder collecting tank 38 is disposed forward of the printing tank 32. The excess powder collecting tank 38 is disposed rearward of a nozzle checker 40 (which will be described below). As illustrated in FIG. 2, the excess powder collecting tank 38 is parallel or substantially parallel to the printing tank 32 in the right-left direction Y such that the right end of the excess powder collecting tank 38 and the right end of the printing tank 32 are located along an imaginary line extending in the scanning direction X, and the left end of the excess powder collecting tank 38 and the left end of the printing tank 32 are located along an imaginary line extending in the scanning direction X. In the plan view, a length L1 of the printing space 32A of the printing tank 32 in the right-left direction Y (i.e., a length of the printing table 34 in the right-left direction Y) is equal to a length L2 of the storing space 38A of the excess powder collecting tank 38 in the right-left direction Y. Alternatively, the length L1 of the printing space 32A may be shorter or longer than the length L2 of the storing space 38A.

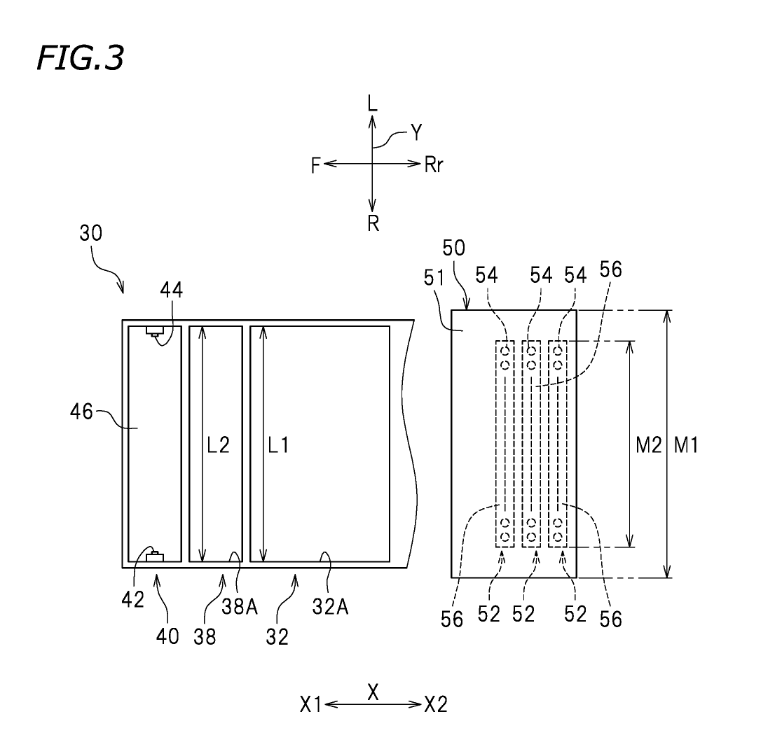

As illustrated in FIG. 3, the head unit 50 according to the present preferred embodiment includes three line heads 52 arranged in the scanning direction X; and a case 51 holding the line heads 52. Each line head 52 discharges the curing liquid onto the powder material 90 placed on the printing table 34. The curing liquid binds particles of the powder material 90. Each line head 52 is an example of a discharge head. As illustrated in FIG. 1, the head unit 50 is supported by the body 10 such that the line heads 52 are located above the holder 30. The body 10 includes an upper surface 11 provided with a pair of supports 58 (see also FIG. 2). The head unit 50 is secured to a cross member 59 extending between the supports 58. Thus, the line heads 52 are immovable in the right-left direction Y. The cross member 59 extends in the right-left direction Y and connects the supports 58 to each other. As illustrated in FIG. 3, a length M1 of the case 51 of the head unit 50 in the right-left direction Y is longer than the length L1 of the printing space 32A of the printing tank 32 in the right-left direction Y. A length M2 of each line head 52 in the right-left direction Y is shorter than the length L1 of the printing space 32A of the printing tank 32 in the right-left direction Y. Each line head 52 may discharge the curing liquid in any mode. In one example, each line head 52 discharges the curing liquid in an inkjet mode. Each line head 52 includes nozzles 54 to discharge the curing liquid; and a nozzle surface 56 provided with the nozzles 54. The nozzles 54 of each line head 52 are disposed in a straight line in the right-left direction Y. The nozzle surface 56 of each line head 52 is located below the lower surface of the case 51. Each line head 52 is electrically connected to the controller 60. The controller 60 controls discharge of the curing liquid from the nozzles 54 of each line head 52.

As illustrated in FIG. 1, the powder feeder 20 feeds the powder material 90 into the printing tank 32 of the holder 30. The powder feeder 20 is disposed above the holder 30. The powder feeder 20 is disposed forward of the line heads 52. The powder feeder 20 is disposed downstream of the line heads 52 in the scanning direction X. The powder feeder 20 includes a storage tank 22 and a feeder 24.

The storage tank 22 stores the powder material 90. The storage tank 22 is disposed above the holder 30. As illustrated in FIG. 2, the upper surface 11 of the body 10 is provided with two upwardly extending supports 26. The supports 26 are parallel or substantially parallel to each other in the scanning direction X such that the front ends of the supports 26 are located along an imaginary line extending in the right-left direction Y, and the rear ends of the supports 26 are located along an imaginary line extending in the right-left direction Y. The storage tank 22 is supported by the supports 26. The storage tank 22 is open upward. A length of the storage tank 22 in the front-rear direction X decreases as the storage tank 22 extends downward.

As illustrated in FIG. 1, the bottom surface of the storage tank 22 is provided with a feed port 23. Through the feed port 23, the powder material 90 in the storage tank 22 is fed onto the printing table 34 in the printing tank 32. The feed port 23 has a rectangular shape, for example. Alternatively, the feed port 23 may have any other shape.

As illustrated in FIG. 1, the feeder 24 feeds the powder material 90, stored in the storage tank 22, into the printing space 32A of the printing tank 32. The feeder 24 is not limited to any particular configuration. In one example, the feeder 24 is a rotary valve. The feeder 24 is disposed in the storage tank 22. Specifically, the feeder 24 is disposed in the storage tank 22 such that the feeder 24 is buried in the powder material 90 in the storage tank 22. The feeder 24 is connected with a first drive motor 25. In one example, the first drive motor 25 is attached to the storage tank 22. The first drive motor 25 is electrically connected to the controller 60. With the printing tank 32 located under the feed port 23 of the storage tank 22, driving the first drive motor 25 rotates the feeder 24. The rotation of the feeder 24 stirs the powder material 90 in the storage tank 22. This feeds some of the powder material 90 into the printing space 32A of the printing tank 32 through the feed port 23.

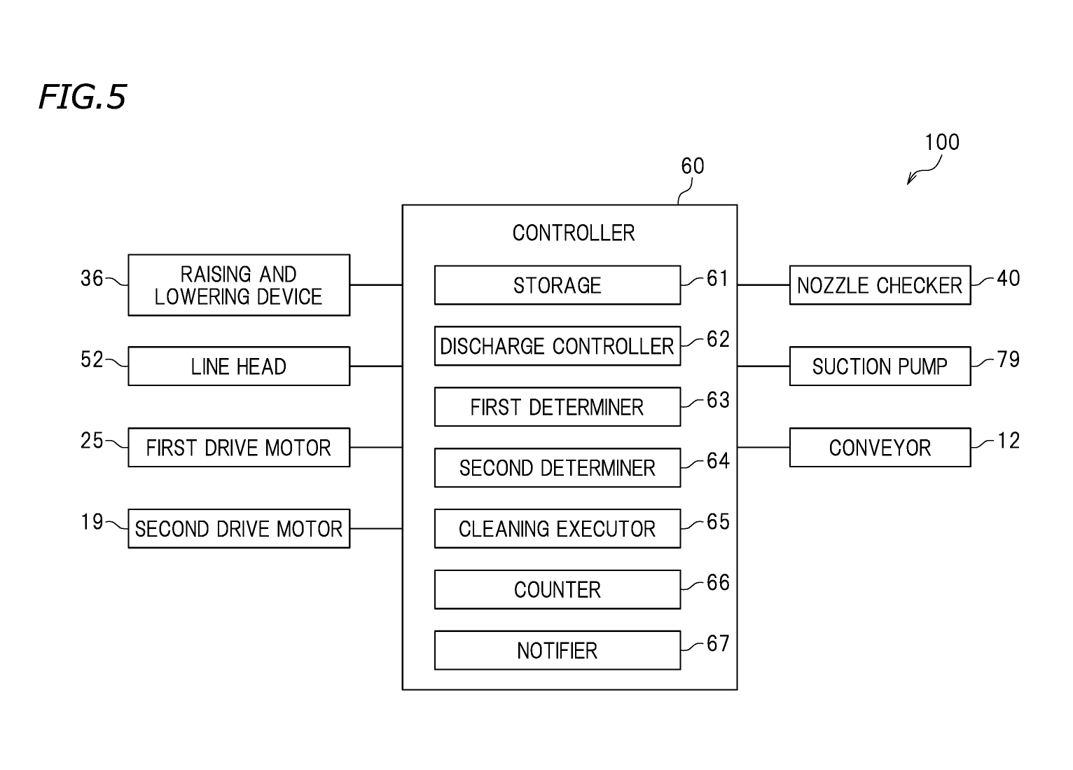

As illustrated in FIG. 1, the powder material 90 fed from the powder feeder 20 is spread through the printing space 32A by the spreading roller 18. The spreading roller 18 flattens the surface of the powder material 90 fed onto the printing table 34. This defines a powder layer having a uniform thickness. The spreading roller 18 is disposed above the body 10. The spreading roller 18 is disposed between the feed port 23 of the storage tank and the line heads 52 in the scanning direction X. The spreading roller 18 is disposed rearward of the feed port 23. The spreading roller 18 is disposed forward of the line heads 52. The spreading roller 18 has an elongated cylindrical shape. The spreading roller 18 is disposed such that its axis extends in the right-left direction Y. A length of the spreading roller 18 in the right-left direction Y is longer than the length L1 of the printing space 32A of the printing tank 32 in the right-left direction Y. The lower end of the spreading roller 18 is disposed slightly above the holder 30 such that a predetermined clearance (or gap) is created between the lower end of the spreading roller and the upper surface 31 of the holder 30. The spreading roller 18 is rotatably supported by the supports 58 disposed on the upper surface 11 of the body 10. The supports 58 extend upward from the upper surface 11. The supports 58 are parallel or substantially parallel to each other in the scanning direction X such that the front ends of the supports 58 are located along an imaginary line extending in the right-left direction Y, and the rear ends of the supports 58 are located along an imaginary line extending in the right-left direction Y. The spreading roller 18 is connected with a second drive motor 19 (see FIG. 5). The second drive motor 19 is electrically connected to the controller 60. Driving the second drive motor 19 rotates the spreading roller 18 in a forward direction or a reverse direction.

As illustrated in FIG. 1, the holder 30 further includes the nozzle checker 40 and a maintenance device 70.

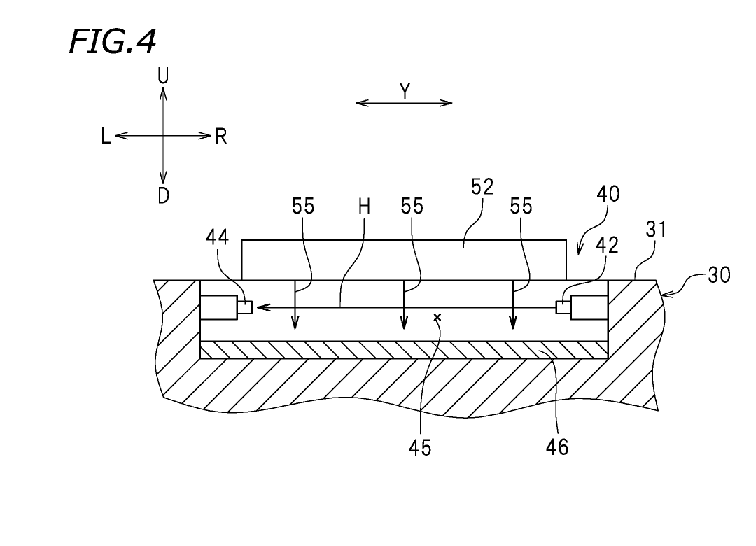

The nozzle checker 40 checks the nozzles 54 (see FIG. 3) of the line heads 52 for discharge failures. The nozzle checker 40 is disposed forward of the excess powder collecting tank 38. As illustrated in FIG. 4, the nozzle checker 40 includes a light emitter 42, a light receiver 44, and a curing liquid receiver 46. The light emitter 42 emits predetermined light H. The light receiver 44 receives the light H emitted from the light emitter 42. The curing liquid receiver 46 receives a curing liquid 55 discharged from the nozzles 54. In one example, the curing liquid receiver 46 is made of a porous material capable of absorbing the curing liquid 55. The curing liquid receiver 46 is attachable to and detachable from the holder 30. The light emitter 42 and the light receiver 44 are disposed to face each other. The nozzle checker 40 includes a detection region 45 defined between the light emitter 42 and the light receiver 44. The nozzle checker 40 checks the nozzles 54 for discharge failures in accordance with a change in light amount that occurs when the curing liquid 55, discharged from the nozzles 54 onto the detection region 45, blocks the light H emitted from the light emitter 42. The nozzle checker 40 may check any one of the nozzles 54 for a discharge failure or may check two or more of the nozzles 54 for discharge failures. The nozzle checker 40 is electrically connected to the controller 60. The nozzle checker 40 may optically detect nozzle clogging by a method similar to that known in the related art. The nozzle checker 40 may detect discharge failure(s) upon determining that the nozzle(s) 54 is/are clogged and unable to discharge the curing liquid 55. The nozzle checker 40 may detect discharge failure(s) upon determining that the nozzle(s) 54 is/are clogged and unable to discharge a predetermined amount of the curing liquid 55. When the nozzle checker 40 detects discharge failure(s) upon determining that the nozzle(s) 54 is/are unable to discharge a predetermined amount of the curing liquid 55, the ratio of an actual discharge amount to an ink discharge trigger number may be measured by a photo-interrupter. The nozzle checker 40 may detect a discharge failure when the ratio measured is equal to or smaller than a preset value.

The maintenance device 70 performs maintenance of the nozzles 54 of the line heads 52. The maintenance device 70 is disposed on a portion of the holder 30 rearward of the printing table 34. The maintenance device 70 is disposed below the line heads 52. The maintenance device 70 includes a flushing stage 72, a wiper 74, and a cap 76. The flushing stage 72, the wiper 74, and the cap 76 are disposed in this order from the downstream side to the upstream side in the scanning direction X. The wiper 74 is disposed rearward of the flushing stage 72. The wiper 74 is disposed forward of the cap 76. The wiper 74 is disposed between the flushing stage 72 and the cap 76 in the scanning direction X.

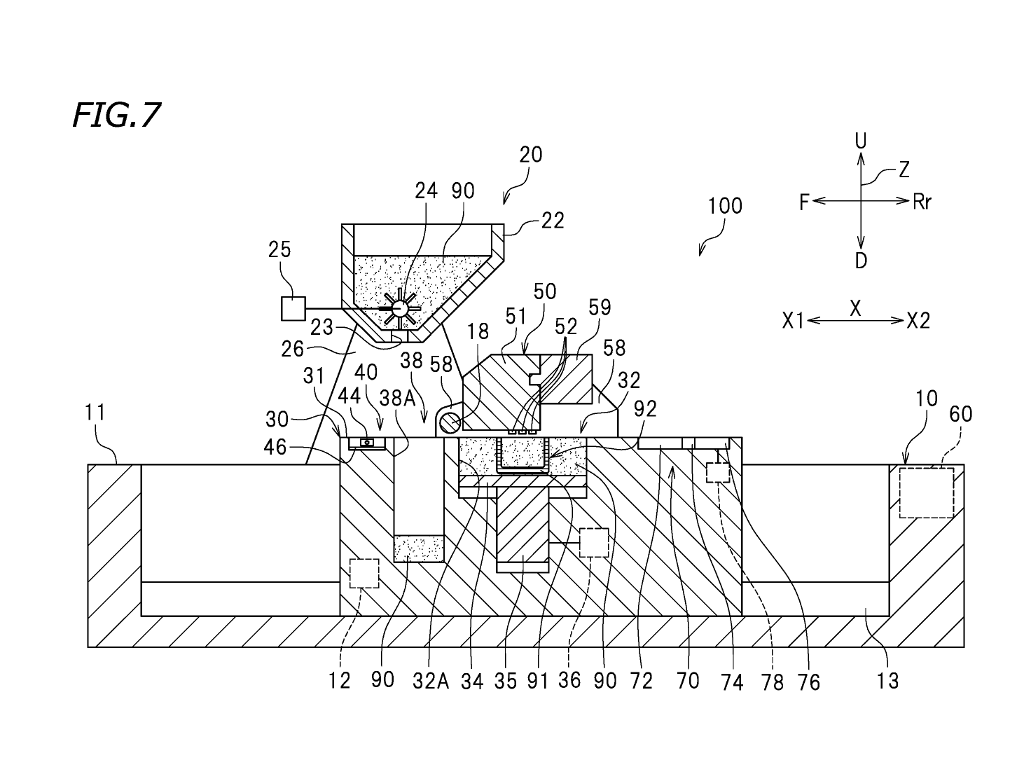

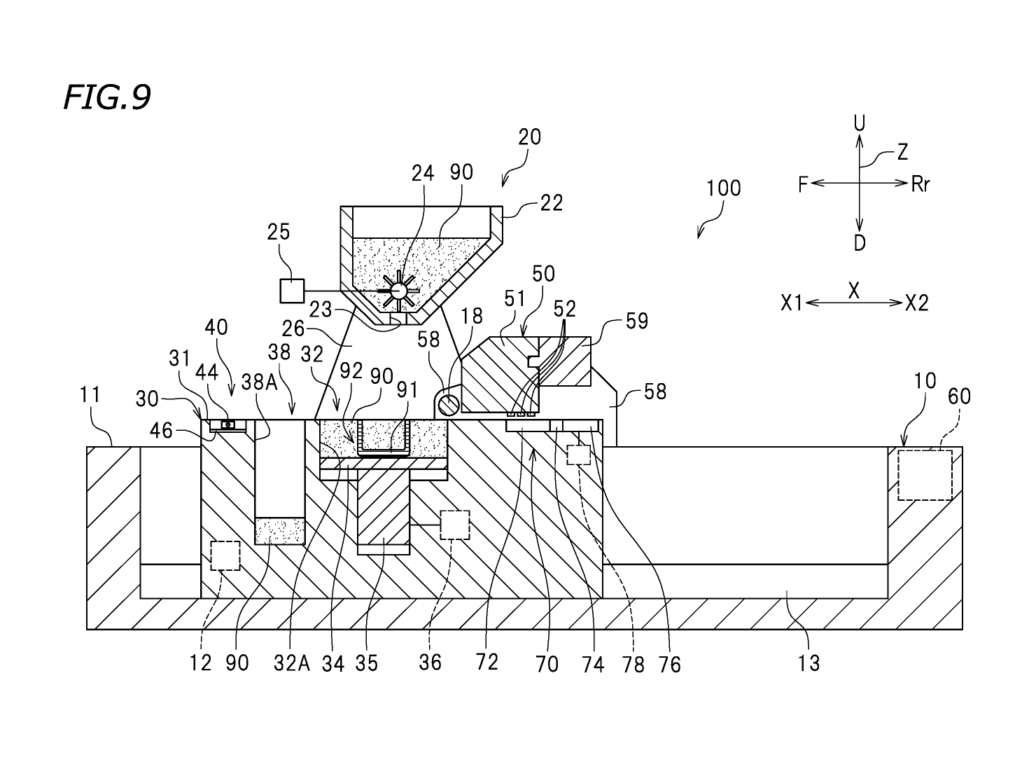

The curing liquid is discharged onto the flushing stage 72 from the nozzles 54 (see FIG. 3). The flushing stage 72 is provided with a porous material capable of absorbing the curing liquid discharged. A length of the flushing stage 72 in the right-left direction Y is equal to or longer than the length M2 (see FIG. 3) of each line head 52 in the right-left direction Y. The three-dimensional printing apparatus 100 performs a flushing operation that involves discharging a predetermined amount of the curing liquid onto the flushing stage 72 from the nozzles 54. In one example, the holder 30 is moved in the direction X2 so as to define one cured layer 91 (see FIG. 7), and then the holder 30 is moved in the direction X1 so as to perform the flushing operation (see FIG. 9). In other words, the flushing operation is performed when the line heads 52 are located over the flushing stage 72. The frequency of performing the flushing operation is not limited to any particular frequency. The flushing operation may be performed each time one cured layer 91 is defined or may be performed each time two or more cured layers 91 are continuously defined. The flushing operation is an example of a cleaning operation (which will be described below).

The wiper 74 wipes the nozzle surface 56 (see FIG. 3) of each line head 52. The wiper 74 comes into contact with the nozzle surfaces 56 when the line heads 52 pass over the wiper 74. The wiper 74 is a plate member made of rubber, for example. A length of the wiper 74 in the right-left direction Y is equal to or longer than a length of each line head 52 between the leftmost nozzle 54 and the rightmost nozzle 54.

The cap 76 prevents clogging of the nozzles 54 caused by cured ink adhering to the nozzle surfaces 56 of the line heads 52. During printing standby (i.e., when no three-dimensional object 92 is being printed), the cap 76 is attached to the line heads 52 from below so as to cover the nozzle surfaces 56 (see FIG. 1). In other words, when the head unit 50 is located at a home position HP, the cap 76 is attached to the line heads 52. As used herein, the term “home position HP” refers to a position where the head unit 50 is put on standby during printing standby (i.e., when no three-dimensional object 92 is being printed or no nozzle check is being conducted). The cap 76 is movable in the up-down direction Z by a cap conveyor 78. Attaching the cap 76 to the line heads 52 defines an enclosed space between the cap 76 and the nozzle surfaces 56. Before the start of printing, the cap conveyor 78 moves the cap 76 downward so as to move the cap 76 away from the nozzle surfaces 56. This detaches the cap 76 from the line heads 52.

The maintenance device 70 includes a suction pump 79 (see FIG. 5) to suck a fluid (e.g., the curing liquid or air) in the enclosed space, with the cap 76 attached to the line heads 52. Sucking the fluid inside the enclosed space by the suction pump 79 depressurizes the enclosed space such that the pressure inside the enclosed space is lower than atmospheric pressure. This forcedly discharges the curing liquid from the nozzles 54 of the line heads 52. In other words, the suction pump 79 sucks the curing liquid in the nozzles 54 of the line heads 52. The fluid sucked from the enclosed space by the suction pump 79 is stored in a waste fluid tank (not illustrated). The suction pump 79 is electrically connected to the controller 60 and is thus controlled by the controller 60. The sucking operation just described is performed to eliminate discharge failures in the nozzles 54. The sucking operation is an example of the cleaning operation (which will be described below).

The conveyor 12 moves the holder 30 relative to the head unit 50, the powder feeder 20, and the spreading roller 18 in the scanning direction X (i.e., in the onward direction X1 and the backward direction X2). In the present preferred embodiment, the conveyor 12 moves the holder 30 within the body 10 in the scanning direction X so as to move the holder 30 relative to the head unit 50, the powder feeder 20, and the spreading roller 18 in the scanning direction X. The conveyor 12 is not limited to any particular configuration. In one example, the conveyor 12 includes: a pair of pulleys (not illustrated); a belt wound around the pulleys; and a drive motor to drive the pulley(s). The belt is secured to the holder 30, for example. Thus, driving the drive motor moves the holder 30 along the guide rails 13 in the scanning direction X. The conveyor 12 is disposed in the body 10. The conveyor 12 is electrically connected to the controller 60 and is thus controlled by the controller 60.

The controller 60 controls all operations of the three-dimensional printing apparatus 100. As illustrated in FIG. 5, the controller 60 is communicably connected to the raising and lowering device 36, the line heads 52, the first drive motor 25, the second drive motor 19, the nozzle checker 40, the suction pump 79, and the conveyor 12. The controller 60 is configured or programmed to control the raising and lowering device 36, the line heads 52, the first drive motor 25, the second drive motor 19, the nozzle checker 40, the suction pump 79, and the conveyor 12. The controller 60 is typically a computer. In one example, the controller 60 includes: an interface (I/F) to receive print data and other data from an external device, such as a host computer; a central processing unit (CPU) to execute a command of a control program; a read-only memory (ROM) to store the program to be executed by the CPU; a random-access memory (RAM) to be used as a working area where the program is to be expanded; and a storage (such as a memory) to store the program and various other data.

The controller 60 is configured or programmed to include a storage 61, a discharge controller 62, a first determiner 63, a second determiner 64, a cleaning executor 65, a counter 66, and a notifier 67. The functions of these elements of the controller 60 are implemented by program(s). The program(s) is/are read from a storage medium, such as a CD or a DVD. Alternatively, the program(s) may be downloaded through the Internet. The functions of the elements of the controller 60 may be implemented by, for example, processor(s) and/or circuit(s). The specific functions of these elements will be described below.

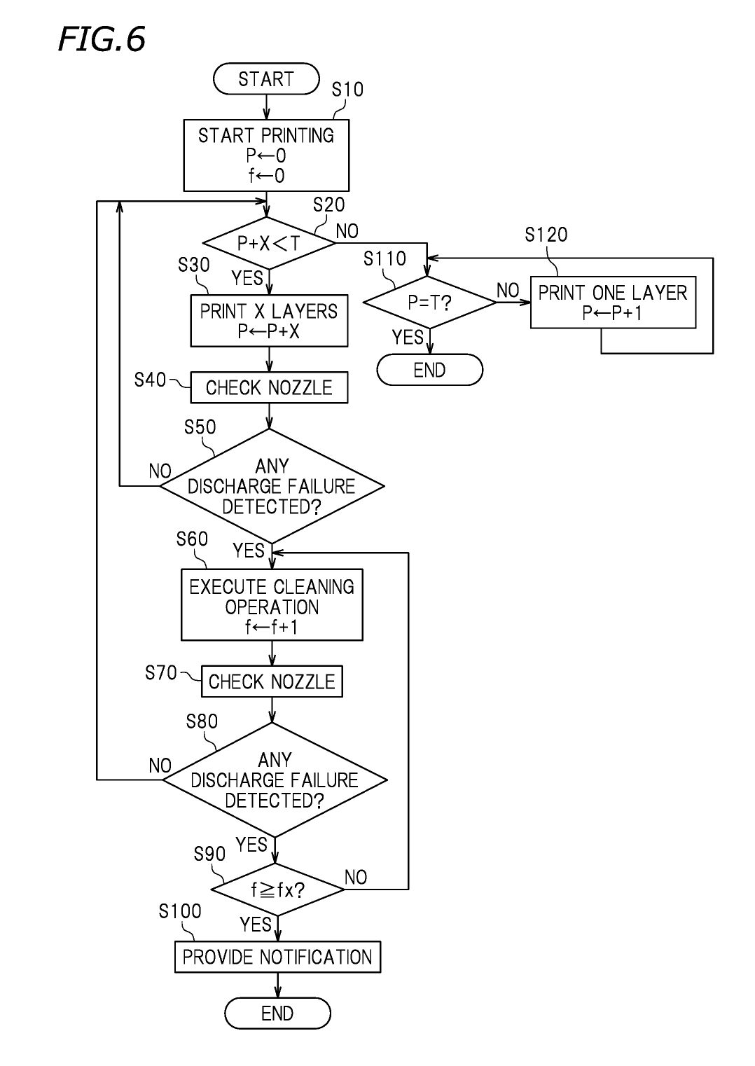

FIG. 6 is a flow chart illustrating a procedure for printing the three-dimensional object 92. As illustrated in FIG. 6, the three-dimensional printing apparatus 100 regularly checks the nozzles 54 for discharge failures in printing the three-dimensional object 92. When necessary, the three-dimensional printing apparatus 100 executes the cleaning operation for the nozzles 54.

The storage 61 stores the timing for checking the nozzles 54 for discharge failures by the nozzle checker 40. In one example, the storage 61 stores information indicating that the nozzle checker 40 should check the nozzles 54 for discharge failures each time a predetermined number of the cured layers 91 are stacked. In the present preferred embodiment, the storage 61 stores information indicating that the nozzle checker 40 should check the nozzles 54 for discharge failures each time X cured layers 91 are stacked (where X is an integer equal to or greater than one). In one example, X may be between 5 and 20 inclusive.

The storage 61 stores printing data for the three-dimensional object 92. In one example, the printing data for the three-dimensional object 92 is a cross-sectional image indicative of a cross-sectional shape of the three-dimensional object 92. In accordance with the printing data, the storage 61 stores the number T of cured layers 91 to be stacked from the start of printing to the end of printing. The number T of cured layers 91 to be stacked from the start of printing to the end of printing will hereinafter be referred to as a “total stacked number T”.

In step S10, the controller 60 starts three-dimensional printing in accordance with the printing data. In this step, the counter 66 sets the number P of stacked cured layers 91 at zero. The number P of stacked cured layers 91 will hereinafter be referred to as a “stacked number P”. The counter 66 sets a cleaning execution count f at zero.

In step S20, the first determiner 63 adds, to the stacked number P, the number X of cured layers 91 to be stacked (which is the number of cured layers 91 to be stacked before the nozzle checker 40 checks the nozzles 54 for discharge failures), and determines whether the sum of the number X and the stacked number P is smaller than the total stacked number T. In other words, the first determiner 63 determines whether P+X<T. When P+X<T, the procedure goes to step S30. When P+X≥T, the procedure goes to step S110.

In step S30, the discharge controller 62 controls the conveyor 12 so as to move the holder 30 and causes the nozzles 54 of the line heads 52 to discharge the curing liquid onto the powder material 90, placed on the printing table 34, in accordance with the printing data (see FIG. 7). The discharge controller 62 controls the conveyor 12 such that the holder 30 reciprocates in the scanning direction X so as to stack X cured layers 91. The discharge controller 62 drives the first drive motor 25 at a predetermined time so as to feed the powder material 90 into the printing space 32A of the printing tank 32 from the powder feeder 20. The counter 66 counts the stacked number P. Because the X cured layers 91 are stacked, the counter 66 adds the value of “X” to the stacked number P in step S30.

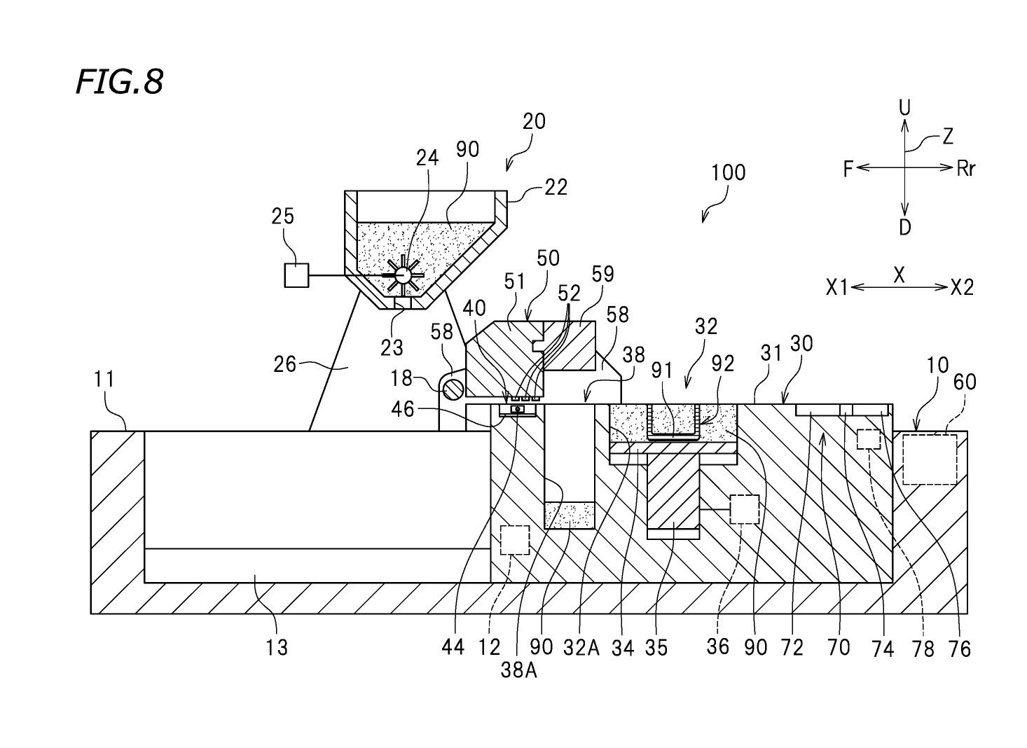

In step S40, the discharge controller 62 controls the conveyor 12 so as to move the holder 30 such that the nozzle checker 40 is located under the line heads 52 (see FIG. 8). The discharge controller 62 then causes the nozzles 54 of the line heads 52 to discharge the curing liquid onto the curing liquid receiver 46 of the nozzle checker 40. The nozzle checker 40 thus checks each nozzle 54 for a discharge failure. The discharge controller 62 causes the nozzles 54 to discharge the curing liquid onto the nozzle checker 40 each time the X cured layers 91 are stacked.

In step S50, the second determiner 64 determines whether cleaning of the nozzle(s) 54 is necessary in accordance with the result of checking by the nozzle checker 40. In one example, the second determiner 64 may determine that cleaning is necessary when a discharge failure has occurred in any one of the nozzles 54. In another example, the second determiner 64 may determine that cleaning is necessary when discharge failures have occurred in a predetermined number or more of the nozzles 54. In still another example, the second determiner 64 may determine that cleaning is necessary when discharge failures have occurred continuously in the nozzles 54 adjacent to each other (e.g., three or more of the nozzles 54 adjacent to each other). In other words, the second determiner 64 may determine that cleaning is unnecessary when discharge failures have not occurred continuously in the nozzles adjacent to each other although discharge failures have occurred in two or more of the nozzles 54. The operator may appropriately preset criteria to determine whether cleaning is necessary. Such criteria are stored in the storage 61. When the second determiner 64 determines that cleaning is necessary, the procedure goes to step S60. When the second determiner 64 determines that cleaning is unnecessary, the procedure returns to step S20.

In step S60, the cleaning executor 65 executes the cleaning operation that involves discharging the curing liquid from the nozzles 54. The cleaning operation includes the flushing operation and the sucking operation. Specifically, the cleaning executor 65 controls the conveyor 12 so as to move the holder 30 such that the maintenance device 70 is located under the line heads 52. The cleaning executor 65 then executes the flushing operation that involves discharging a predetermined amount of the curing liquid onto the flushing stage 72 from the nozzles 54 (see FIG. 9). The cleaning executor 65 executes the sucking operation that involves driving the suction pump 79 so as to suck the fluid in the enclosed space defined between the cap 76 and the nozzle surfaces 56 and thus discharge the curing liquid from the nozzles (see FIG. 1). The cleaning executor 65 may be configured or programmed to execute either one of the flushing operation and the sucking operation in accordance with how much the nozzle(s) is/are clogged. For example, when the nozzle(s) 54 is/are relatively slightly clogged, the cleaning executor 65 executes the flushing operation so as to unclog the nozzle(s) 54. In step S60, the counter 66 adds the value “1” to the cleaning execution count f.

In step S70, the discharge controller 62 controls the conveyor 12 so as to move the holder 30 such that the nozzle checker 40 is located under the line heads 52 (see FIG. 8). The discharge controller 62 then causes the nozzles 54 of the line heads 52 to discharge the curing liquid onto the curing liquid receiver 46 of the nozzle checker 40. The nozzle checker 40 thus checks each nozzle 54 for a discharge failure. The discharge controller 62 causes the nozzles 54 to discharge the curing liquid onto the nozzle checker 40 each time the cleaning operation is executed.

In step S80, the second determiner 64 determines whether further cleaning of the nozzle(s) 54 is necessary in accordance with the result of checking by the nozzle checker 40. Upon determination by the second determiner 64 that further cleaning is necessary, the procedure goes to step S90. Upon determination by the second determiner 64 that further cleaning is unnecessary, the procedure returns to step S20.

In step S90, the first determiner 63 determines whether the cleaning execution count f is equal to or greater than a predetermined threshold value fx. Upon determination by the first determiner 63 that the cleaning execution count f is equal to or greater than the predetermined threshold value fx, the procedure goes to step S100. Upon determination by the first determiner 63 that the cleaning execution count f is smaller than the predetermined threshold value fx, the procedure returns to step S60. The cleaning executor 65 thus repeatedly executes the cleaning operation under predetermined conditions until the second determiner 64 determines that cleaning of the nozzle(s) 54 is unnecessary.

In step S100, the notifier 67 notifies the operator of abnormal condition(s) of the nozzle(s) 54. When the cleaning execution count f counted by the counter 66 has reached the predetermined threshold value fx, the notifier 67 notifies the operator of abnormal condition(s) of the nozzle(s) 54.

Specifically, the notifier 67 notifies the operator that a more sophisticated maintenance operation should be executed instead of a normal maintenance operation because the cleaning operation has failed to unclog the nozzle(s) 54. The notifier 67 may provide a notification to the operator in any suitable manner. In one example, the notifier 67 may provide a notification through visual display, sound, and/or other indicator. In the present preferred embodiment, the notifier 67 visually notifies the operator through a display device (not illustrated), for example.

In step S110, the first determiner 63 determines whether the stacked number P is equal to the total stacked number T. In other words, the first determiner 63 determines whether P=T. When P=T, the controller 60 ends three-dimensional printing started in accordance with the printing data. The three-dimensional printing apparatus 100 thus ends the process of printing the three-dimensional object 92. When P<T, the procedure goes to step S120.

In step S120, the discharge controller 62 controls the conveyor 12 so as to move the holder 30 and causes the nozzles 54 of the line heads 52 to discharge the curing liquid onto the powder material 90, placed on the printing table 34, in accordance with the printing data (see FIG. 7). This stacks one cured layer 91. In step S120, the counter 66 adds the value “1” to the stacked number P. The procedure then returns to step S110.

As described above, the holder 30 of the three-dimensional printing apparatus 100 according to the present preferred embodiment is provided with the nozzle checker 40. The discharge controller 62 of the controller 60 causes the nozzles 54 of the line heads 52 to discharge the curing liquid onto the nozzle checker 40. The nozzle checker 40 is able to check the nozzles 54 for discharge failures. The three-dimensional printing apparatus 100 thus causes the nozzles 54 to discharge the curing liquid onto the nozzle checker 40 before the start of printing of the three-dimensional object 92 and/or in the course of printing of the three-dimensional object 92, so as to detect whether each nozzle 54 is clogged. In the event of discharge failure(s) in the nozzle(s) 54, the operator may stop the printing of the three-dimensional object 92 so as to perform maintenance of the nozzle(s) 54.

The discharge controller 62 of the three-dimensional printing apparatus 100 according to the present preferred embodiment causes the nozzles 54 to discharge the curing liquid onto the nozzle checker 40 each time the X cured layers 91 are stacked. The three-dimensional printing apparatus 100 is thus able to regularly determine whether the nozzle(s) 54 is/are clogged in the course of printing. This prevents the three-dimensional printing apparatus 100 from continuing three-dimensional printing, with the nozzle(s) 54 being clogged. Consequently, the three-dimensional printing apparatus 100 is able to suitably cure the powder material 90 so as to sequentially define the cured layers 91 of high strength.

The controller 60 of the three-dimensional printing apparatus 100 according to the present preferred embodiment includes the second determiner 64 and the cleaning executor 65. The second determiner 64 determines whether cleaning of the nozzle(s) 54 is necessary in accordance with the result of checking by the nozzle checker 40. The cleaning executor 65 executes the cleaning operation that involves discharging the curing liquid from the nozzle(s) 54 upon determination by the second determiner 64 that cleaning of the nozzle(s) 54 is necessary. Upon determination by the second determiner 64 that cleaning of the nozzle(s) 54 is necessary, the cleaning executor 65 executes the cleaning operation so as to unclog the nozzle(s) 54.

The discharge controller 62 of the three-dimensional printing apparatus 100 according to the present preferred embodiment causes the nozzles 54 to discharge the curing liquid onto the nozzle checker 40 after the cleaning operation. The cleaning executor 65 repeatedly executes the cleaning operation until the second determiner 64 determines that cleaning of the nozzle(s) 54 is unnecessary. Consequently, the three-dimensional printing apparatus 100 is able to more reliably unclog the nozzle(s) 54 and thus change the nozzle(s) 54 back to normal.

The controller 60 of the three-dimensional printing apparatus 100 according to the present preferred embodiment further includes the counter 66 and the notifier 67. The counter counts the cleaning execution count f for the cleaning operation. The notifier 67 provides a notification that the nozzle(s) 54 is/are in an abnormal condition when the cleaning execution count f counted by the counter 66 has reached the predetermined threshold value fx. This notifies the operator that the cleaning operation has failed to unclog the nozzle(s) 54.

The cleaning operation to be performed by the three-dimensional printing apparatus 100 according to the present preferred embodiment includes the flushing operation and the sucking operation. The flushing operation involves discharging the curing liquid from the nozzles 54. The sucking operation involves sucking the fluid in the enclosed space by the suction pump 79 so as to discharge the curing liquid from the nozzles 54. When the nozzle(s) 54 is/are relatively slightly clogged, the three-dimensional printing apparatus 100 performs the flushing operation that involves discharging a relatively small amount of the curing liquid. When the nozzle(s) 54 is/are relatively heavily clogged, the three-dimensional printing apparatus 100 performs, in addition to the flushing operation, the sucking operation that involves discharging a relatively large amount of the curing liquid. Because the three-dimensional printing apparatus 100 performs the flushing operation when the nozzle(s) is/are relatively slightly clogged, the three-dimensional printing apparatus 100 is able to change the nozzle(s) 54 back to normal while reducing the amount of curing liquid to be discharged from the nozzle(s) 54.

The three-dimensional printing apparatus 100 according to the present preferred embodiment preferably includes the excess powder collecting tank 38 disposed downstream of the printing tank 32 of the holder 30 in the scanning direction X; and the nozzle checker 40 disposed downstream of the excess powder collecting tank 38 in the scanning direction X. The nozzle checker 40 is thus spaced away from the printing tank 32. Consequently, the three-dimensional printing apparatus 100 enables the nozzle checker 40 to check the nozzles 54 for discharge failures, while reducing the influence of the powder material 90 that may swirl up during feed of the powder material 90 into the printing tank 32.

The nozzle checker 40 of the three-dimensional printing apparatus 100 according to the present preferred embodiment checks the nozzles 54 for discharge failures in accordance with a change in light amount that occurs when the curing liquid 55, discharged onto the detection region 45, blocks the light H emitted from the light emitter 42. The nozzle checker 40 is thus able to more accurately check the nozzles 54 for discharge failures.

### Second Preferred Embodiment

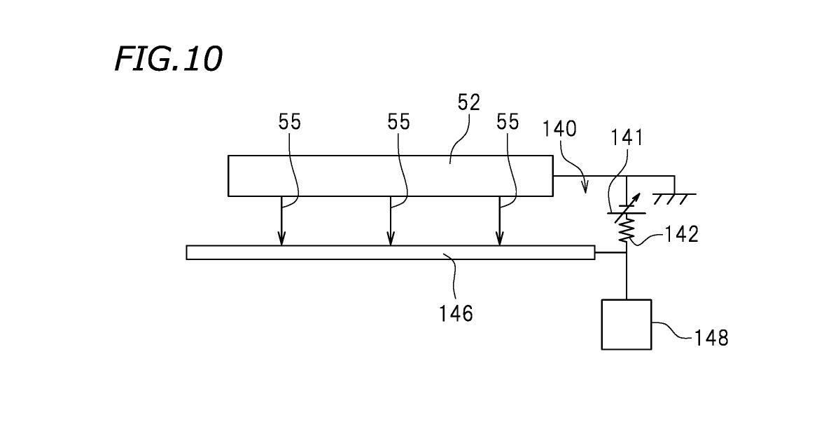

FIG. 10 is a schematic diagram illustrating a nozzle checker 140 according to a second preferred embodiment of the present invention. The nozzle checker 140 includes a power supply 141, a resistor 142, an electrode plate 146, and a voltage change detector 148. The power supply 141 applies a voltage to the electrode plate 146 such that the line heads 52 become a negative side and the electrode plate 146 becomes a positive side. This creates an electric field between the electrode plate 146 and the line heads 52, so that the curing liquid 55 discharged from the line heads 52 is negatively charged, and the electrode plate 146 is positively charged. The power supply 141 and the resistor 142 define and function as a voltage applicator. The curing liquid 55 discharged from the nozzles 54 hits on the electrode plate 146. The electrode plate 146 is held in a recess provided in the holder 30. The electrode plate 146 may be made of conductive metal, for example. The voltage change detector 148 detects an electrical change that occurs when the negatively charged curing liquid 55 reaches the electrode plate 146. In other words, the voltage change detector 148 measures a voltage value when the electrically charged curing liquid 55 hits on the electrode plate 146. When the voltage value measured is equal to or greater than a predetermined threshold value, the voltage change detector 148 detects no discharge failure in the nozzles 54. When the voltage value measured is smaller than the predetermined threshold value, the voltage change detector 148 detects discharge failure(s) in the nozzle(s) 54. The nozzle checker 140 may electrically detect whether the nozzle(s) 54 is/are clogged by a method similar to that known in the art.

The nozzle checker 140 of the three-dimensional printing apparatus 100 according to the present preferred embodiment checks the nozzles 54 for discharge failures in accordance with an electrical change that occurs when the electrically charged curing liquid 55 reaches the electrode plate 146. The nozzle checker 140 is thus able to accurately check the nozzles 54 for discharge failures.

Although the preferred embodiments of the present invention have been described thus far, the preferred embodiments described above are only illustrative. The present invention may be embodied in various other forms.

In each of the foregoing preferred embodiments, the maintenance device 70 is disposed rearward of the printing tank 32, and the nozzle checker 40 is disposed forward of the printing tank 32. Alternatively, the maintenance device 70 and the nozzle checker 40 may be disposed at any other locations. In one example, the maintenance device 70 may be disposed forward of the printing tank 32, and the nozzle checker 40 may be disposed rearward of the printing tank 32. In another example, the nozzle checker 40 and the maintenance device 70 may be disposed adjacent to each other in the scanning direction X. Such an arrangement reduces the distance by which the holder 30 moves. This quickly changes the nozzle(s) 54 back to normal in the event of discharge failure(s) in the nozzle(s) 54.

In each of the foregoing preferred embodiments, the powder feeder 20, the spreading roller 18, and the head unit 50 are secured to the body 10, and the holder 30 moves relative to the powder feeder 20, the spreading roller 18, and the head unit 50 in the scanning direction X. The present invention, however, is not limited to this arrangement. In one example, the holder 30 and the powder feeder 20 may be secured to the body 10, and the spreading roller 18 and the head unit 50 may move relative to the holder 30 and the powder feeder 20 in the scanning direction X.

In each of the foregoing preferred embodiments, the nozzle checker 40 checks the nozzles 54 for discharge failures in the course of printing of the three-dimensional object 92. The nozzle checker 40 may check the nozzles 54 for discharge failures at any other time(s). The nozzle checker 40 may check the nozzles for discharge failures before the start of printing of the three-dimensional object 92 and/or after the end of printing of the three-dimensional object 92.

The three-dimensional printing apparatus 100 includes the line heads 52 extending in the right-left direction Y and immovable in the right-left direction Y. The three-dimensional printing apparatus 100 does not necessarily have to include the line heads 52. In one example, the three-dimensional printing apparatus 100 may include an inkjet head whose length in the right-left direction Y is shorter than the length of each line head 52 in the right-left direction Y. In this case, a carriage may be mounted on the cross member 59, and the inkjet head may be movable together with the carriage in the right-left direction Y.

In each of the foregoing preferred embodiments, the powder material 90 is fed into the printing tank 32 by dropping the powder material 90 into the printing tank 32 from the powder feeder 20. Alternatively, the powder material 90 may be fed into the printing tank 32 in any other suitable manner. The three-dimensional printing apparatus 100 may include a feeding tank that stores the powder material 90. The feeding tank may be disposed on one side relative to the printing tank 32 (e.g., rearward of the printing tank 32) in the scanning direction X. The feeding tank may be provided with a feeding table on which the powder material 90 is to be placed. In this case, the feeding table may be raised and the spreading roller 18 may be moved in the scanning direction X so as to push out the powder material 90 on the feeding table by the spreading roller 18, thus feeding the powder material 90 into the printing tank 32 from the feeding tank.

The terms and expressions used herein are for description only and are not to be interpreted in a limited sense. These terms and expressions should be recognized as not excluding any equivalents to the elements shown and described herein and as allowing any modification encompassed in the scope of the claims. The present invention may be embodied in many various forms. This disclosure should be regarded as providing preferred embodiments of the principles of the present invention. These preferred embodiments are provided with the understanding that they are not intended to limit the present invention to the preferred embodiments described in the specification and/or shown in the drawings. The present invention is not limited to the preferred embodiments described herein. The present invention encompasses any of preferred embodiments including equivalent elements, modifications, deletions, combinations, improvements and/or alterations which can be recognized by a person of ordinary skill in the art based on the disclosure. The elements of each claim should be interpreted broadly based on the terms used in the claim, and should not be limited to any of the preferred embodiments described in this specification or used during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A three-dimensional printing apparatus to print a three-dimensional object by sequentially stacking cured layers each defined by a cured powder material, the three-dimensional printing apparatus comprising:
a holder to hold the three-dimensional object being printed;
a printing tank disposed in the holder and including a printing space in which the powder material is to be stored;
a printing table on which the powder material is to be placed and located in the printing space of the printing tank;
a discharge head including:
a plurality of nozzles to discharge a curing liquid onto the powder material placed on the printing table; and
a nozzle surface provided with the nozzles;
a conveyor to move one of the holder and the discharge head relative to the other one of the holder and the discharge head in a first direction;
a nozzle checker disposed in the holder to check at least one of the nozzles for a discharge failure; and
a controller to control discharge of the curing liquid from the nozzles; wherein
the controller includes a discharge controller to cause the nozzles to discharge the curing liquid onto the nozzle checker.

2. The three-dimensional printing apparatus according to claim 1, wherein the nozzle checker checks the nozzles for discharge failures.

3. The three-dimensional printing apparatus according to claim 1, wherein the discharge controller causes the nozzles to discharge the curing liquid onto the nozzle checker each time a predetermined number of the cured layers are stacked.

4. The three-dimensional printing apparatus according to claim 1, wherein the controller further includes:
a determiner to determine whether cleaning of at least one of the nozzles is necessary in accordance with a result of checking by the nozzle checker; and
a cleaning executor to execute a cleaning operation upon determination by the determiner that cleaning of at least one of the nozzles is necessary, the cleaning operation involving discharging of the curing liquid from the at least one of the nozzles.

5. The three-dimensional printing apparatus according to claim 4, wherein
the discharge controller causes the nozzles to discharge the curing liquid onto the nozzle checker after the cleaning operation; and
the cleaning executor repeatedly executes the cleaning operation until the determiner determines that cleaning of the at least one of the nozzles is unnecessary.

6. The three-dimensional printing apparatus according to claim 5, wherein the controller further includes:
a counter to count a number of times the cleaning operation has been executed; and
a notifier to provide a notification that at least one of the nozzles is in a defective condition when the number of times counted by the counter has reached a predetermined threshold value.

7. The three-dimensional printing apparatus according to claim 4, further comprising:
a cap detachably attachable to the discharge head so as to cover the nozzle surface and define an enclosed space between the cap and the nozzle surface; and
a suction pump to suck a fluid in the enclosed space and controlled by the controller; wherein
the cleaning operation includes at least one of:
a flushing operation that involves discharging the curing liquid from at least one of the nozzles; and
a sucking operation that involves sucking the fluid in the enclosed space by the suction pump so as to discharge the curing liquid from at least one of the nozzles.

8. The three-dimensional printing apparatus according to claim 1, further comprising an excess powder collecting tank disposed on one side relative to the printing tank of the holder in the first direction to collect an excess portion of the powder material that is not stored in the printing space, wherein
the nozzle checker is disposed on the one side relative to the excess powder collecting tank in the first direction.

9. The three-dimensional printing apparatus according to claim 1, wherein the nozzle checker includes:
a light emitter to emit predetermined light; and
a light receiver to receive the light emitted from the light emitter; wherein
a detection region is defined between the light emitter and the light receiver; and
the nozzle checker checks the nozzles for discharge failures in accordance with a change in light amount that occurs when the curing liquid discharged onto the detection region blocks the light emitted from the light emitter.

10. The three-dimensional printing apparatus according to claim 1, wherein the nozzle checker includes:
a plate on which the curing liquid discharged from the nozzles hits; and
a voltage applicator to apply a voltage to the plate so as to create an electric field and electrically charge the curing liquid to be discharged from the nozzles; and
the nozzle checker checks the nozzles for discharge failures in accordance with an electrical change that occurs when the electrically charged curing liquid reaches the plate.
